(19) United States
(12) Patent Application Publication
(10) Pub. No.: US 2026/0217581 A1
(43) Pub. Date: Jul. 30, 2026

(54) RAPID GRANULAR SLUDGE CULTIVATION DEVICE AND METHOD FOR CONTINUOUS FLOW ANAEROBIC AMMONIUM OXIDATION PROCESS

(71) Applicant: BEIJING DRAINAGE GROUP CO., LTD, Beijing (CN)

(72) Inventors: Dan Zhao, Beijing (CN); Xiaoyu Han, Beijing (CN); Shujun Zhang, Beijing (CN); Xiaocong Wang, Beijing (CN); Jiatong Jiao, Beijing (CN); Jing Huang, Beijing (CN)

(21) Appl. No.: 19/152,085

(22) PCT Filed: Sep. 5, 2024
(86) PCT No.: PCT/CN2024/117163

§ 371 Date: Jul. 30, 2025

(30) Foreign Application Priority Data
Dec. 19, 2023 (CN) 202311752286.4

(51) Int. Cl. C02F 3/30; C02F 1/00; C02F 3/00

(52) U.S. Cl. CPC C02F 3/307; C02F 3/006; C02F 2001/007; C02F 2003/001; C02F 2203/004; C02F 2209/006; C02F 2209/008; C02F 2209/02; C02F 2209/06; C02F 2209/14; C02F 2209/22; C02F 2301/046

(57) ABSTRACT

The present disclosure provides a rapid granular sludge cultivation device and method for continuous flow anaerobic ammonium oxidation process, the device comprising: a raw water tank (1), a chemical dissolving tank (2), a biological reaction tank (3) and a secondary sedimentation tank (4); the biological reaction tank (3) is provided with a built-in sedimentation three-phase separation tank (3.8) and a blank filler (3.3). This device can utilize the inhibition of low DO, FA, and FNA to achieve partial nitritation of ammonia nitrogen in high ammonia nitrogen sewage. At the same time, the gradient changes of ammonia nitrogen concentration in each compartment and the continuous recirculation enhancement of sludge enable the partial nitritation reaction to be stably maintained, enhance the efficiency of partial nitritation, and enhance the system's ability to resist low temperature shocks. The biological reaction tank (3) is equipped with a built-in sedimentation three-phase separation tank (3.8). By setting different surface loads and upward flow rates, it is possible to achieve three-phase separation of gas, liquid and solid in each compartment, effectively intercept large particle sludge, wash floc sludge, and achieve the effect of sludge screening. This device can achieve efficient nitrogen removal while relatively quickly forming anammox granular sludge.

### FIELD OF TECHNOLOGY

The present disclosure relates to the technical field of high ammonia nitrogen sewage treatment, and more specifically, relates to rapid granular sludge cultivation device and method for continuous flow anaerobic ammonium oxidation process.

### BACKGROUND

High ammonia nitrogen wastewater contains a high ammonia nitrogen concentration. If a traditional sewage treatment process is used, it will not only greatly increase construction and operation cost, but also produce a large amount of greenhouse gases, which will have an adverse impact on the ecological environment. At the same time, the requirements for nitrogen content in effluent and greenhouse gas emissions from sewage treatment plants are becoming increasingly strict, which makes the use of new high ammonia nitrogen wastewater treatment processes an inevitable trend.

Partial nitritation and anammox technology is an emerging autotrophic nitrogen removal technology in recent years. Compared with traditional nitrification and denitrification technology, it has a shorter reaction path, faster rate, and reduces greenhouse gas emissions by more than 90%. It has the advantages of no need for external carbon sources, low sludge production, and low energy consumption. It is currently internationally recognized as the most cost-effective and efficient sewage biological nitrogen removal technology.

At present, the application of partial nitritation and anammox technology is mainly in the form of integrated processes, and the sludge forms of this process are mainly suspended sludge and biofilm sludge. Granular sludge is an aggregation of multiple functional microorganisms, which possess the advantages of both biofilm and activated sludge—good settling performance and high biological activity. The use of granular sludge as a carrier for partial nitritation and anammox reactions can achieve larger volumetric loads and good operational stability in a single reactor, making it more economically advantageous and controllable in terms of operation management and promotion compared to biofilm devices and two-stage treatment devices.

However, the application of partial nitritation and anammox granular sludge technology in large-scale sewage treatment still faces many difficulties, especially the long cultivation period of granular sludge, long process start-up time, decreased stability of granular sludge during long-term operation, and the complex operation and management mode of SBR and its variants, which greatly limit the large-scale application of partial nitritation and anammox granular sludge technology. Therefore, the improvement and enhancement of the partial nitritation and anammox granular sludge process have been increasingly valued. Meanwhile, exploring the application of partial nitritation and anammox granular sludge in continuous flow operation mode for treating high ammonia nitrogen sewage has also become a research hotspot in anammox biological treatment of sewage.

The present disclosure is proposed based on the research background, aiming to use an efficient continuous flow partial nitritation and anammox process to rapidly cultivate granular sludge, improve partial nitritation efficiency and total nitrogen volumetric load, enhance device stability, and create an operating mode for continuous flow partial nitritation and anammox granular sludge process to treat high ammonia nitrogen sewage.

### SUMMARY

The purpose of the present disclosure is to provide a rapid granular sludge cultivation device for continuous flow anaerobic ammonium oxidation process to overcome the shortcomings of the prior art, and to solve the difficulties faced by the application of partial nitritation and anammox granular sludge technology in large-scale sewage treatment, especially the problems of long cultivation cycle of granular sludge, long process start-up time, decreased stability of granular sludge during long-term operation, and the complex operation and management mode limited by SBR and its variants.

In order to achieve the above objectives, the present disclosure provides a rapid granular sludge cultivation device for continuous flow anaerobic ammonium oxidation process, comprising:
a raw water tank, a chemical dissolving tank, a biological reaction tank and a secondary sedimentation tank;
the raw water tank is an open box, and the raw water tank is provided with a first water inlet pipe, an overflow pipe and a first vent pipe; the raw water tank is connected to a water inlet pipeline valve of the biological reaction tank through a water outlet pump;
the chemical dissolving tank is a semi-closed tank, and the chemical dissolving tank is provided with a second water inlet pipe, a second vent pipe, and a stirrer; the chemical dissolving tank is connected to the water inlet pipeline valve of the biological reaction tank through a dosing pump;
the biological reaction tank comprises a tank body, which is provided with a plurality of compartments in sequence, each compartment is provided with a built-in sedimentation three-phase separation tank, a blank filler and an aerator sequentially from top to bottom, a lower end of the compartment at a tail end is connected to the compartment at a head end, and an upper end of the compartment at the tail end is connected to the secondary sedimentation tank through a water inlet pipe of the secondary sedimentation tank;
the secondary sedimentation tank is a vertical flow sedimentation tank, an upper end of the secondary sedimentation tank is provided with a water outlet pipe of the secondary sedimentation tank, the secondary sedimentation tank is connected to the compartment at the head end of the biological reaction tank through a sludge pump and a recirculation sludge pipe, and a residual sludge pipe is provided at a bottom of the secondary sedimentation tank;
an online data monitoring device, the online data monitoring device comprises an online detector for dissolved oxygen concentration, an online detector for ammonia nitrogen concentration, and an online detector for pH;
a temperature control device, the temperature control device comprises a heating rod, a temperature sensor and a temperature regulator;
a controller, the controller is a PLC module and is connected to the aerator, the temperature control device and the online data monitoring device through a wireless transceiver and a communication line.

Optionally, each of the compartments and the corresponding built-in sedimentation three-phase separation tank are respectively provided with different surface loads and rising flow rates.

Optionally, the blank filler is a string of polyethylene sponge fillers.

Optionally, a baffle extending vertically upward is provided outside an effluent weir of the built-in sedimentation three-phase separation tank, the baffle is configured to prevent floating sludge from entering the effluent weir.

Optionally, the aerator is connected to a blower through an air pipe, a gas flow regulating valve and a gas flow meter.

The present disclosure also provides a rapid granular sludge cultivation method for continuous flow anaerobic ammonium oxidation process, using the rapid granular sludge cultivation device for continuous flow anaerobic ammonium oxidation process, comprising:
step 1: adding activated sludge with nitrification taken from an aeration pool of an urban sewage plant into remaining space of the biological reaction tank excluding the built-in sedimentation three-phase separation tank, inoculating mixed sludge containing anammox bacteria into each compartment of the biological reaction tank, wherein after inoculating the sludge, an activated sludge concentration MLSS is 3000~4000 mg/L; adding the urban sewage into the raw water tank, starting the water outlet pump to make the urban sewage to pass through the inlet pipe valve of the biological reaction tank and enter the biological reaction tank; adding the urban sewage into the chemical dissolving tank, starting the stirrer of the chemical dissolving tank, and putting in ammonium bicarbonate and sodium bicarbonate to proportion sewage water quality of high ammonia nitrogen; starting the dosing pump, adjusting flow of the water outlet pump and the dosing pump according to actual operating conditions and total nitrogen volume load to control ammonia nitrogen concentration and pH value in the biological reaction tank;
step 2: starting the blower, adjusting the gas flow regulating valve so that dissolved oxygen (DO) in the biological reaction tank is less than 0.5 mg/L; starting the sludge pump, and controlling internal recirculation ratio of the sludge and external recirculation ratio of the sludge according to formation of the granular sludge;
step 3: turning on the temperature control device to control a temperature of mixed liquid in the biological reaction tank at 28~35° C.;
step 4: according to nitrite nitrogen, nitrate nitrogen, and the pH value of each compartment of the biological reaction tank, adjusting influent flow, dosage, aeration volume, and sludge recirculation ratio to control an influent NH₄⁺—N load;
step 5: continuously increasing an ammonia nitrogen load of the influent and increasing the aeration volume to quickly increase a total nitrogen volume load of the biological reaction tank, and enhancing hydraulic shear force to accelerate granulation of functional microorganisms;
step 6: periodically changing a matrix concentration of the device to form a negative pressure in the matrix in each compartment and stimulate the granulation of functional microorganisms.

Optionally, the ammonia nitrogen concentration of the compartment at the head end is 200~600 mg/L, and the pH value is 7.8~8.4.

Optionally, the ammonia nitrogen concentration of the compartment at the tail end is not less than 20 mg/L, and the pH value is not less than 7.

Optionally, the external recirculation ratio of the sludge is 50%~300%, and the internal recirculation ratio of the sludge is less than 300%.

Optionally, the method comprising putting in ammonium bicarbonate and sodium bicarbonate into the chemical dissolving tank in a ratio of 1:1 to 2:1 to obtain a proportioned liquid.

The present disclosure provides a rapid granular sludge cultivation device for continuous flow anaerobic ammonium oxidation process, and the beneficial effects lie in:
1. This device can utilize the inhibition of low DO, FA, and FNA to achieve partial nitritation of ammonia nitrogen in high ammonia nitrogen sewage. At the same time, the gradient changes of ammonia nitrogen concentration in each compartment and the continuous recirculation enhancement of sludge enable the partial nitritation reaction to be stably maintained, enhance the efficiency of partial nitritation, increase the nitrification volume load, and enhance the system's ability to resist low temperature shocks. In addition, by continuously increasing the total nitrogen load and gradually enhancing the aeration shear force, the biological reaction tank is conducive to the formation of anammox granular sludge. At the same time, the biological reaction tank is equipped with a built-in sedimentation three-phase separation tank. By setting different surface loads and upward flow rates, it is possible to achieve three-phase separation of gas, liquid and solid in each compartment, effectively intercept large particle sludge, wash floc sludge, and achieve the effect of sludge screening. Moreover, the new fixed filler in the biological reaction tank can attach a large number of functional microorganisms during the operation of the system, providing a foundation for the stable operation of the system. This system can achieve efficient nitrogen removal while relatively quickly forming anammox granular sludge.
2. The rapid granular sludge cultivation device for continuous flow anaerobic ammonium oxidation process stores urban sewage in a raw water tank, and uses a chemical dissolving tank to mix proportioned liquids of different concentrations, thereby changing the water quality of urban sewage and providing a suitable cultivation water environment. The biological reaction tank is used for producing sludge particles, which can achieve the effect of enhancing partial nitritation efficiency and increasing nitrification volumetric load by using the periodic gradient changes of ammonia nitrogen concentration in each compartment, combined with the built-in sedimentation three-phase separation tank for recirculation washing, to increase the growth rate of AOB compared to NOB. At the same time, the blank filler can attach a large number of functional microorganisms during the initial and middle stages of operation, providing a foundation for the stable operation of the device and rapidly forming anammox granular sludge.
3. This device is suitable for efficient continuous flow partial nitritation and anammox process, which can quickly cultivate granular sludge, improve partial nitritation efficiency and total nitrogen volumetric load, enhance the stability of the device, and create an operating mode for continuous flow partial nitritation and anammox granular sludge process to treat high ammonia nitrogen sewage.
4. The device has the advantages of stable operation, low maintenance cost, relatively low energy consumption, and no need to add additional carbon sources. It can achieve rapid cultivation of anammox granular sludge, realize the rapid promotion and application of granular sludge process, and save land occupation and operating cost.

Other features and advantages of the present disclosure will be described in detail in the following detailed description.

### BRIEF DESCRIPTION OF THE DRAWINGS

The above and other objects, features and advantages of the present disclosure will become more apparent by describing the exemplary embodiments of the present disclosure in more detail with reference to the accompanying drawings, in which the same reference numeral generally refers to the same component in the exemplary embodiments of the present disclosure.

FIG. 1 shows a schematic structural diagram of a rapid granular sludge cultivation device for continuous flow anaerobic ammonium oxidation process according to an embodiment of the present disclosure.

FIG. 2 shows a schematic structural diagram of a built-in sedimentation three-phase separation tank of a rapid granular sludge cultivation device for continuous flow anaerobic ammonium oxidation process according to an embodiment of the present disclosure.

FIG. 3 shows a schematic structural diagram of a blank filler of a rapid granular sludge cultivation device for continuous flow anaerobic ammonium oxidation process according to an embodiment of the present disclosure.

### DESCRIPTION OF REFERENCES

1. raw water tank; 2. chemical dissolving tank; 3. biological reaction tank; 4. secondary sedimentation tank;
1.1. first water inlet pipe; 1.2. first vent pipe; 1.3. water outlet pump of raw water tank; 1.4. urban sewage flow meter; 1.5. overflow pipe of raw water tank; 1.6. water inlet pipeline valve;
2.1. second water inlet pipe; 2.2. second vent pipe; 2.3. stirrer; 2.4. dosing pump; 2.5. dosing flow meter;
3.1. blower; 3.2. aerator; 3.3. blank filler; 3.4. sludge pump; 3.5. sludge pipeline valve; 3.6. temperature control device; 3.7. online data monitoring device; 3.8. built-in sedimentation three-phase separation tank; 3.9. gas flow regulating valve; 3.10. gas flow meter;
4.1. water inlet pipe of secondary sedimentation tank; 4.2. water outlet pipe of secondary sedimentation tank; 4.3. residual sludge pipe; 4.4. recirculation sludge pipe.

### DESCRIPTION OF THE EMBODIMENTS

Preferred embodiments of the disclosure will be described in more detail below. Although preferred embodiments of the present disclosure are described below, it should be understood that the present invention may be implemented in various forms and should not be limited to the embodiments set forth herein. Rather, these embodiments are provided so that this disclosure will be thorough and complete, and will fully convey the scope of the invention to those skilled in the art.

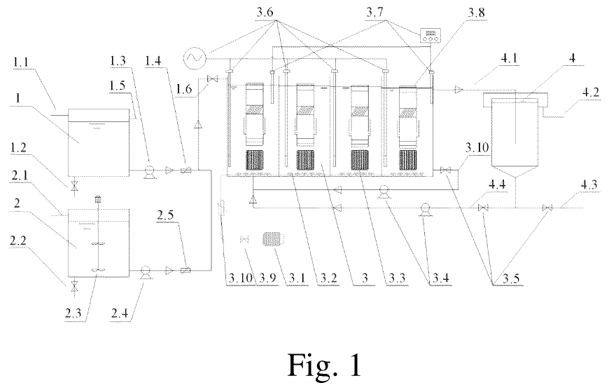

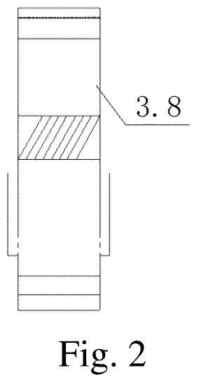

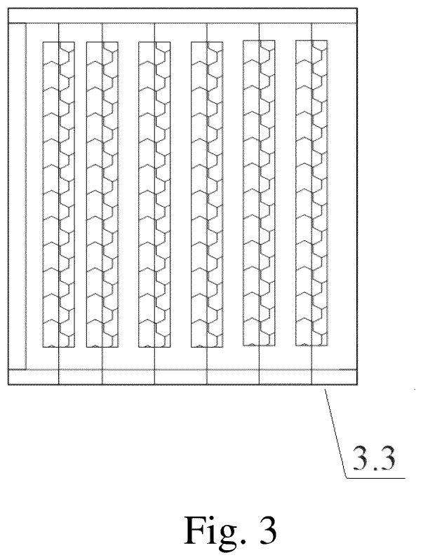

As shown in FIG. 1 to FIG. 3, a rapid granular sludge cultivation device for continuous flow anaerobic ammonium oxidation process, comprising:
a raw water tank 1, a chemical dissolving tank 2, a biological reaction tank 3 and a secondary sedimentation tank 4;
the raw water tank 1 is an open box, and the raw water tank 1 is provided with a first water inlet pipe 1.1, an overflow pipe 1.5 and a first vent pipe 1.2; the raw water tank 1 is connected to a water inlet pipeline valve 1.6 of the biological reaction tank 3 through a water outlet pump 1.3;
the chemical dissolving tank 2 is a semi-closed tank, and the chemical dissolving tank 2 is provided with a second water inlet pipe 2.1, a second vent pipe 2.2, and a stirrer 2.3; the chemical dissolving tank 2 is connected to the water inlet pipeline valve 1.6 of the biological reaction tank 3 through a dosing pump 2.4;
the biological reaction tank 3 comprises a tank body, which is provided with a plurality of compartments in sequence, each compartment is provided with a built-in sedimentation three-phase separation tank 3.8, a blank filler 3.3 and an aerator 3.2 sequentially from top to bottom, a lower end of the compartment at a tail end is connected to the compartment at a head end, and an upper end of the compartment at the tail end is connected to the secondary sedimentation tank 4 through a water inlet pipe of the secondary sedimentation tank 4.1;
the secondary sedimentation tank 4 is a vertical flow sedimentation tank, an upper end of the secondary sedimentation tank 4 is provided with a water outlet pipe of the secondary sedimentation tank 4.2, the secondary sedimentation tank 4 is connected to the compartment at the head end of the biological reaction tank 3 through a sludge pump 3.4 and a recirculation sludge pipe 4.4, and a residual sludge pipe 4.3 is provided at a bottom of the secondary sedimentation tank 4;
an online data monitoring device 3.7, the online data monitoring device 3.7 comprises an online detector for dissolved oxygen concentration, an online detector for ammonia nitrogen concentration, and an online detector for pH;
a temperature control device 3.6, the temperature control device 3.6 comprises a heating rod, a temperature sensor and a temperature regulator;
a controller, the controller is a PLC module and is connected to the aerator, the temperature control device 3.6 and the online data monitoring device 3.7 through a wireless transceiver and a communication line.

Specifically, urban sewage is stored in the raw water tank 1, and proportioned liquids of different concentrations are proportioned through the chemical dissolving tank 2, thereby changing the water quality of urban sewage by mixing the proportioned liquids with urban sewage and providing a suitable cultivation water environment. The biological reaction tank 3 is used for producing sludge particles, which can achieve the effect of enhancing partial nitritation efficiency and increasing nitrification volumetric load by using the periodic gradient changes of ammonia nitrogen concentration in each compartment, combined with the built-in sedimentation three-phase separation tank 3.8 for recirculation washing, to make the growth rate of AOB greater than that of NOB. At the same time, the blank filler 3.3 can attach a large number of functional microorganisms during the initial and middle stages of operation, providing a foundation for the stable operation of the device, and quickly forming anammox granular sludge. The operation of the device is controlled in real-time through the online data monitoring device 3.7 and the temperature control device 3.6 to ensure that the water environment parameters in the biological reaction tank 3 meet the operating requirements of different modes, and the device automatically switches operating modes to ensure stable automated operation.

Furthermore, the number of compartments can be set as needed, with ammonia nitrogen concentrations of 200~600 mg/L and pH values continuously changing according to the number of compartments. Only the specific parameters of the compartments at the head end and at the tail end need to be detected. By using the chemical dissolving tank 2 to proportion proportioned liquids of different concentrations, the influent in the biological reaction tank is made to have water quality of high ammonia nitrogen.

In this embodiment, each compartment and its corresponding built-in sedimentation three-phase separation tank 3.8 are respectively provided with different surface loads and rising flow rates.

Specifically, by setting different surface loads and rising flow rates, it is possible to achieve three-phase separation of gas, liquid and solid in each compartment, effectively intercepting large particle sludge, washing floc sludge, and achieving the effect of sludge screening.

In this embodiment, the blank filler 3.3 is a string of polyethylene sponge fillers.

Specifically, the blank filler 3.3 can attach a large number of functional microorganisms, providing a foundation for the stable operation of the device and enhancing its ability to resist impact loads.

In this embodiment, a baffle extending vertically upward is provided outside an effluent weir of the built-in sedimentation three-phase separation tank 3.8, the baffle is configured to prevent floating sludge from entering the effluent weir.

Specifically, each compartment in the biological reaction tank 3 is equipped with a built-in sedimentation three-phase separation tank 3.8. The sludge and water mixture in the compartment enters from the bottom and diffuses upwards, and the supernatant and sludge are separated through inclined plate sedimentation. The sinking sludge slides into the biological reaction tank 3 through the bottom opening and participates in nitrogen removal reaction again. However, in actual operation, the bubbles generated by anammox reaction will adhere to the microbial flocs, causing sludge to float up and then be lost. By installing upper and lower baffles on both sides of the effluent weir, the floating sludge is separated from the effluent weir to prevent the loss of sludge.

In this embodiment, the aerator 3.2 is connected to the blower 3.1 through a gas pipe, a gas flow regulating valve 3.9, and a gas flow meter 3.10.

Specifically, the airflow is provided by the blower 3.1, and the aeration rate is controlled by the gas flow regulating valve 3.9 and the gas flow meter 3.10. The gas flow regulating valve 3.9 and gas flow meter 3.10 are also connected to the controller.

The present disclose also provides a rapid granular sludge cultivation method for continuous flow anaerobic ammonium oxidation process, using the rapid granular sludge cultivation device for continuous flow anaerobic ammonium oxidation process, comprising:
step 1: adding nitrifying activated sludge taken from an aeration pool of an urban sewage plant into remaining space of the biological reaction tank 3 excluding the built-in sedimentation three-phase separation tank 3.8, inoculating mixed sludge containing anammox bacteria into each compartment of the biological reaction tank 3, wherein after inoculating the sludge, an activated sludge concentration MLSS is 3000~4000 mg/L; adding the urban sewage into the raw water tank 1, starting the water outlet pump 1.3 to make the urban sewage to pass through the inlet pipe valve 1.6 of the biological reaction tank 3 and enter the biological reaction tank 3; adding the urban sewage into the chemical dissolving tank 2, starting the stirrer 2.3 of the chemical dissolving tank 2, and putting in ammonium bicarbonate and sodium bicarbonate to proportion sewage water quality of high ammonia nitrogen; starting the dosing pump 2.4, adjusting flow of the water outlet pump 1.3 and the dosing pump 2.4 according to actual operating conditions and total nitrogen volume load to control ammonia nitrogen concentration and pH value in the biological reaction tank 3;
step 2: starting the blower 3.1, adjusting the gas flow regulating valve 3.9 so that dissolved oxygen DO in the biological reaction tank is less than 0.5 mg/L; starting the sludge pump 3.4, and controlling internal recirculation ratio of the sludge and external recirculation ratio of the sludge according to formation of the granular sludge;
step 3: turning on the temperature control device 3.6 to control the temperature of mixed liquid in the biological reaction tank 3 at 28~35° C.;
step 4: according to nitrite nitrogen, nitrate nitrogen, and the pH value of each compartment of the biological reaction tank 3, adjusting influent flow, dosage, aeration volume, and sludge recirculation ratio to control an influent NH₄⁺—N load;
step 5: continuously increasing an ammonia nitrogen load of the influent and increasing the aeration volume to quickly increase the total nitrogen volume load of the biological reaction tank 3, and enhancing hydraulic shear force to accelerate granulation of functional microorganisms;
step 6: periodically changing a matrix concentration of the device to form a negative pressure in the matrix in each compartment and stimulate the granulation of functional microorganisms.

Specifically, this method utilizes the inhibition of low DO, FA, and FNA to achieve partial nitritation of ammonia nitrogen in high ammonia nitrogen sewage; at the same time, the gradient changes of ammonia nitrogen concentration in each compartment and the continuous recirculation enhancement of sludge enable the partial nitritation reaction to be stably maintained, that is, the growth rate of AOB is greater than that of NOB, so that NOB is continuously suppressed and washed away, increasing the amount of AOB contained in its unit sludge, thereby enhancing the partial nitritation efficiency, increasing the nitrification volume load, and enhancing the ability of the device to resist low-temperature impact. In addition, by continuously increasing the total nitrogen load and gradually enhancing the aeration shear force, the biological reaction tank is conducive to the formation of anammox granular sludge. At the same time, the biological reaction tank is equipped with a built-in sedimentation three-phase separation tank 3.8. By setting different surface loads and upward flow rates, it is possible to achieve three-phase separation of gas, liquid and solid in each compartment, effectively intercept large particle sludge, wash floc sludge, and achieve the effect of sludge screening. Moreover, the blank filler 3.3 in the biological reaction tank 3 can attach a large number of functional microorganisms during the middle stage of the operation of the device, providing a foundation for the stable operation of the device, and simultaneously achieving efficient nitrogen removal and rapidly forming anammox granular sludge.

This method has inherent characteristics of partial nitritation and anammox: low oxygen consumption, reduced energy consumption, no need for additional carbon sources, and significant advantages for nitrogen removal of high ammonia nitrogen sewage lacking carbon sources; low sludge production reduces the cost of sludge disposal and operation.

In this embodiment, the ammonia nitrogen concentration of the compartment at the head end is 200~600 mg/L, and the pH value of the compartment at the head end is 7.8~8.4.

In this embodiment, the ammonia nitrogen concentration of the compartment at the tail end is not less than 20 mg/L, and the pH value of the compartment at the tail end is not less than 7.

In this embodiment, the external recirculation ratio of the sludge is 50%~300%, and the internal recirculation ratio of the sludge is less than 300%.

In this embodiment, the method comprising putting in ammonium bicarbonate and sodium bicarbonate into the chemical dissolving tank 2 in a ratio of 1:1 to 2:1 to obtain a proportioned liquid.

### Embodiment 1

The embodiment provides use of a rapid granular sludge cultivation device for continuous flow anaerobic ammonium oxidation process, and takes use of urban sewage as an example.
1. Adding nitrifying activated sludge taken from an aeration pool of an urban sewage plant into remaining space of the biological reaction tank 3 excluding the built-in sedimentation three-phase separation tank 3.8, inoculating mixed sludge containing anammox bacteria into each compartment of the biological reaction tank 3, wherein after inoculating the sludge, an activated sludge concentration MLSS is 3000~4000 mg/L; adding the urban sewage into the raw water tank 1, starting the water outlet pump 1.3 to make the urban sewage to pass through the inlet pipe valve 1.6 of the biological reaction tank 3 and enter the biological reaction tank 3; adding the urban sewage into the chemical dissolving tank 2, starting the stirrer 2.3 of the chemical dissolving tank 2, and putting in ammonium bicarbonate and sodium bicarbonate in a ratio of 1:1 to 2:1 to simulate sewage water quality of actual high ammonia nitrogen and ensure the matrix concentration and basicity of the influent; starting the dosing pump 2.4, adjusting flow of the water outlet pump 1.3 and the dosing pump 2.4 to control the ammonia nitrogen concentration of the compartment at the head end of the biological reaction tank 3 at 200~600 mg/L, and the pH value at 7.8~8.4, and control the ammonia nitrogen concentration of the compartment at the tail end at not less than 20 mg/L, and the pH value not less than 7.
2. Starting the blower 3.1, adjusting the gas flow regulating valve 3.9 so that dissolved oxygen DO in the biological reaction tank 3 is less than 0.5 mg/L; starting the sludge pump 3.4, and controlling the external recirculation ratio of the sludge at 50%~300%, and the internal recirculation ratio of the sludge less than 300%.
3. Turning on the temperature control device 3.6 to control the temperature of mixed liquid in the biological reaction tank 3 at 28~35° C.
4. According to nitrite nitrogen, nitrate nitrogen, and the pH value of each compartment of the biological reaction tank 3, controlling the total nitrogen of the effluent less than 100 mg/L, adjusting influent NH₄⁺—N load, that is, adjusting influent flow, dosage, aeration volume, and sludge recirculation ratio.
5. After the device operates stably, continuously increasing the ammonia nitrogen load of the influent and increasing the aeration volume to quickly increase the total nitrogen volume load of the biological reaction tank 3 to enrich a large number of functional microorganisms.
6. Continuously increasing the aeration volume of the device and enhancing hydraulic shear force to accelerate granulation of functional microorganisms.
7. Periodically changing a matrix concentration of the device to form a negative pressure in the matrix in each compartment and stimulate the granulation of functional microorganisms.

Phase 1: The operation time is 15 days, and the ammonia nitrogen concentration in the compartment at the head end is maintained at 200~300 mg/L. The aeration volume is adjusted to ensure that the DO in the biological reaction tank is not higher than 0.5 mg/L.

Phase 2: The operation time is 15 days, and the ammonia nitrogen concentration in the compartment at the head end is maintained at 500~600 mg/L. The aeration volume is adjusted to ensure that the DO in the biological reaction tank is not higher than 0.5 mg/L.

Operate alternately and repeatedly according to this operating cycle.
8. Each compartment in the biological reaction tank 3 is provided with a built-in sedimentation three-phase separation tank 3.8. During operation, the surface load of the built-in sedimentation three-phase separation tank 3.8 is set to be less than 0.5 m³/(m²·h) based on the inflow rate and the recirculation rate of the biological reaction tank. As the particle size in the device gradually increases, determine the floc sludge washing volume according to the current sludge concentration and load of the device and gradually increase the surface load to 1.5~2.5 m³/(m²·h).

The urban sewage used in this embodiment comes from the effluent of the primary sedimentation tank of a certain urban sewage plant. The effluent quality of the primary sedimentation tank is: COD of 106.1~182.4 mg/L, NH₄⁺—N of 40.24~64.97 mg/L, NO₂⁻—N of 0.00~1.12 mg/L, NO₃⁻—N of 0.11~1.19 mg/L; SS of 60~138 mg/L; TP of 3.13~8.31 mg/L; basicity of 247~405 mg/L; pH value of 7.02~7.58.

The experiment shows that after stable operation, the operating parameters of the device can be flexibly adjusted, and the operating load steadily increases, reaching 1.2 kgN/m³·d. The total nitrogen removal ratio reaches 85%, and the median particle size reaches over 100 μm after three months of operation.

### Embodiment 2

The difference between Embodiment 2 and Embodiment 1 is that Embodiment 2 installs a perforated aeration device in the biological reaction tank. The perforated aeration method can reduce the dissolved oxygen efficiency of the water body and cause great disturbance to the water body, greatly enhancing the hydraulic shear force of the water body on the granular sludge, which is conducive to the aggregation of small particles and the compaction of granular sludge.

### Embodiment 3

The difference between Embodiment 3 and Embodiment 1 is that Embodiment 3 is equipped with sludge screening and recirculation devices at the end of the device (the outlet of the secondary sedimentation tank) and the outlet of each compartment. The sludge screening and recirculation devices can accelerate the washing of floc sludge, create biological selective pressure on the formation of granular sludge, reduce the loss of granular sludge, and greatly accelerate the formation of partial nitritation and anammox granular sludge.

### Comparison Example 1

The difference between the Comparison example 1 and Embodiment 1 is that there is no built-in sedimentation three-phase separation tank and blank filler in the biological reaction tank, and the rest is the same. In the early and middle stages of particle formation, there is a lack of screening for flocculent sludge and granular sludge in the biological reaction tank. Relying solely on the secondary sedimentation tank cannot effectively retain granular sludge and wash flocculent sludge, which also poses greater difficulties for the operation of the process. The inability to wash floc sludge can greatly increase the risk of partial nitritation reaction destruction, prevent the formation of biological selective pressure, and slow the growth of particle median diameter. When operating in a mode with periodic changes in matrix concentration, it is highly likely to cause sludge swelling that cannot be restored, and even lead to a large loss of functional microorganisms and device collapse.

The above has described various embodiments of the present invention, which are exemplary, not exhaustive, and not limited to the disclosed embodiments. Without deviating from the scope and spirit of the various embodiments described, many modifications and changes are obvious to those skilled in the art.

1. A rapid granular sludge cultivation device for continuous flow anaerobic ammonium oxidation process, comprising:
a raw water tank (1), a chemical dissolving tank (2), a biological reaction tank (3) and a secondary sedimentation tank (4);
the raw water tank (1) is an open box, and the raw water tank (1) is provided with a first water inlet pipe (1.1), an overflow pipe (1.5) and a first vent pipe (1.2); the raw water tank (1) is connected to a water inlet pipeline valve (1.6) of the biological reaction tank (3) through a water outlet pump (1.3);
the chemical dissolving tank (2) is a semi-closed tank, and the chemical dissolving tank (2) is provided with a second water inlet pipe (2.1), a second vent pipe (2.2), and a stirrer (2.3); the chemical dissolving tank (2) is connected to the water inlet pipeline valve (1.6) of the biological reaction tank (3) through a dosing pump (2.4);
the biological reaction tank (3) comprises a tank body, which is provided with a plurality of compartments in sequence, each compartment is provided with a built-in sedimentation three-phase separation tank (3.8), a blank filler (3.3) and an aerator (3.2) sequentially from top to bottom, a lower end of the compartment at a tail end is connected to the compartment at a head end, and an upper end of the compartment at the tail end is connected to the secondary sedimentation tank through a water inlet pipe of the secondary sedimentation tank (4.1);
the secondary sedimentation tank (4) is a vertical flow sedimentation tank, an upper end of the secondary sedimentation tank (4) is provided with a water outlet pipe of the secondary sedimentation tank (4.2), the secondary sedimentation tank (4) is connected to the compartment at the head end of the biological reaction tank (3) through a sludge pump (3.4) and a recirculation sludge pipe (4.4), and a residual sludge pipe (4.3) is provided at a bottom of the secondary sedimentation tank (4);
an online data monitoring device (3.7), the online data monitoring device (3.7) comprises an online detector for dissolved oxygen concentration, an online detector for ammonia nitrogen concentration, and an online detector for pH;
a temperature control device (3.6), the temperature control device (3.6) comprises a heating rod, a temperature sensor and a temperature regulator;
a controller, the controller is a PLC module and is connected to the aerator, the temperature control device (3.6) and the online data monitoring device (3.7) through a wireless transceiver and a communication line.

2. The rapid granular sludge cultivation device for continuous flow anaerobic ammonium oxidation process according to claim 1, wherein each compartment and the corresponding built-in sedimentation three-phase separation tank (3.8) are respectively provided with different surface loads and rising flow rates.

3. The rapid granular sludge cultivation device for continuous flow anaerobic ammonium oxidation process according to claim 1, wherein the blank filler (3.3) is a string of polyethylene sponge fillers.

4. The rapid granular sludge cultivation device for continuous flow anaerobic ammonium oxidation process according to claim 1, wherein a baffle extending vertically upward is provided outside an effluent weir of the built-in sedimentation three-phase separation tank (3.8), the baffle is configured to prevent floating sludge from entering the effluent weir.

5. The rapid granular sludge cultivation device for continuous flow anaerobic ammonium oxidation process according to claim 1, wherein the aerator (3.2) is connected to a blower (3.1) through an air pipe, a gas flow regulating valve (3.9) and a gas flow meter (3.10).

6. A rapid granular sludge cultivation method for continuous flow anaerobic ammonium oxidation process, using the rapid granular sludge cultivation device for continuous flow anaerobic ammonium oxidation process according to claim 5, comprising:
step 1: adding nitrifying activated sludge taken from an aeration pool of an urban sewage plant into remaining space of the biological reaction tank (3) excluding the built-in sedimentation three-phase separation tank (3.8), inoculating mixed sludge containing anammox bacteria into each compartment of the biological reaction tank (3), wherein after inoculating the sludge, an activated sludge concentration MLSS is 3000~4000 mg/L; adding urban sewage into the raw water tank (1), starting the water outlet pump (1.3) to make the urban sewage to pass through the inlet pipe valve (1.6) of the biological reaction tank (3) and enter the biological reaction tank (3); adding urban sewage into the chemical dissolving tank (2), starting the stirrer (2.3) of the chemical dissolving tank (2), and putting in ammonium bicarbonate and sodium bicarbonate to proportion sewage water quality of high ammonia nitrogen; starting the dosing pump (2.4), adjusting flow of the water outlet pump (1.3) and the dosing pump (2.4) according to actual operating conditions and total nitrogen volume load to control ammonia nitrogen concentration and pH value in the biological reaction tank (3);
step 2: starting the blower (3.1), adjusting the gas flow regulating valve (3.9) so that dissolved oxygen (DO) in the biological reaction tank is less than 0.5 mg/L; starting the sludge pump (3.4), and controlling internal recirculation ratio and external recirculation ratio of the sludge according to formation of the granular sludge;
step 3: turning on the temperature control device (3.6) to control a temperature of mixed liquid in the biological reaction tank (3) at 28~35° C.;
step 4: according to nitrite nitrogen, nitrate nitrogen, and the pH value of each compartment of the biological reaction tank (3), adjusting influent flow, dosage, aeration volume, and sludge recirculation ratio to control an influent NH₄⁺—N load;
step 5: continuously increasing an ammonia nitrogen load of the influent and increasing the aeration volume to quickly increase a total nitrogen volume load of the biological reaction tank (3), and enhancing hydraulic shear force to accelerate granulation of functional microorganisms;
step 6: periodically changing a matrix concentration of the device to form a negative pressure in the matrix in each compartment and stimulate the granulation of functional microorganisms.

7. The rapid granular sludge cultivation method for continuous flow anaerobic ammonium oxidation process according to claim 6, wherein the ammonia nitrogen concentration of the compartment at the head end is 200~600 mg/L, and the pH value is 7.8~8.4.

8. The rapid granular sludge cultivation method for continuous flow anaerobic ammonium oxidation process according to claim 6, wherein the ammonia nitrogen concentration of the compartment at the tail end is not less than 20 mg/L, and the pH value is not less than 7.

9. The rapid granular sludge cultivation method for continuous flow anaerobic ammonium oxidation process according to claim 6, wherein an external recirculation ratio of the sludge is 50%~300%, and an internal recirculation ratio of the sludge is less than 300%.

10. The rapid granular sludge cultivation method for continuous flow anaerobic ammonium oxidation process according to claim 6, comprising putting in ammonium bicarbonate and sodium bicarbonate into the chemical dissolving tank (2) in a ratio of 1:1 to 2:1 to obtain a proportioned liquid.
